(19) United States
(12) Patent Application Publication
(10) Pub. No.: US 2021/0243855 A1
(43) Pub. Date: Aug. 5, 2021

(54) Automated Cooking Device

(71) Applicant: Tia S. Burress, Villa Park, IL (US)

(72) Inventor: Tia S. Burress, Villa Park, IL (US)

(21) Appl. No.: 16/781,517

(22) Filed: Feb. 4, 2020

(51) Int. Cl. H05B 6/64; G10L 13/04; H05B 6/68

(52) U.S. Cl. CPC H05B 6/6441; H05B 6/687; G10L 13/043

(57) ABSTRACT

An automated cooking device for utilizing matrix barcodes for automated cooking control includes an appliance that can at least one of heat and cook an article that is positioned therein, such as a foodstuff and a beverage. A controller is operationally coupled to the appliance and can scan a matrix barcode that is positioned on a package containing the article. The matrix barcode encodes at least one of a heating instruction and a cooking instruction. The controller actuates the appliance to implement the at least one of the heating instruction and the cooking instruction to selectively heat and cook the article.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to cooking devices and more particularly pertains to a new cooking device for utilizing matrix barcodes for automated cooking control.

### (2) Description of Related Art Including Information Disclosed Under 37 CFR 1.97 and 1.98

The prior art relates to cooking devices. Prior art automated cooking devices may comprise an appliance having a plurality of sensors that measure weight, humidity, and temperature. Other prior art devices may comprise an appliance that incorporate an internet search device to locate and download cooking instructions, or a scanner that detects color changes in an indicator that correspond to temperature changes in an article being cooked.

### BRIEF SUMMARY OF THE INVENTION

An embodiment of the disclosure meets the needs presented above by generally comprising an appliance that is configured for at least one of heating and cooking an article positioned therein, such as a foodstuff and a beverage. A controller is operationally coupled to the appliance and is configured to scan a matrix barcode that is positioned on a package containing the article. The matrix barcode encodes at least one of a heating instruction and a cooking instruction. The controller is configured to actuate the appliance to implement the at least one of the heating instruction and the cooking instruction to selectively heat and cook the article. As the at least one of the heating instruction and the cooking instruction is provided by a manufacture of the article and directly implemented by the controller, uncertainty in interpreting written instructions for heating or cooking the article is eliminated.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of an automated cooking device according to an embodiment of the disclosure.

FIG. 2 is a front view of an embodiment of the disclosure.

FIG. 3 is a detail view of an embodiment of the disclosure.

FIG. 4 is a block diagram an embodiment of the disclosure.

### DETAILED DESCRIPTION OF THE INVENTION

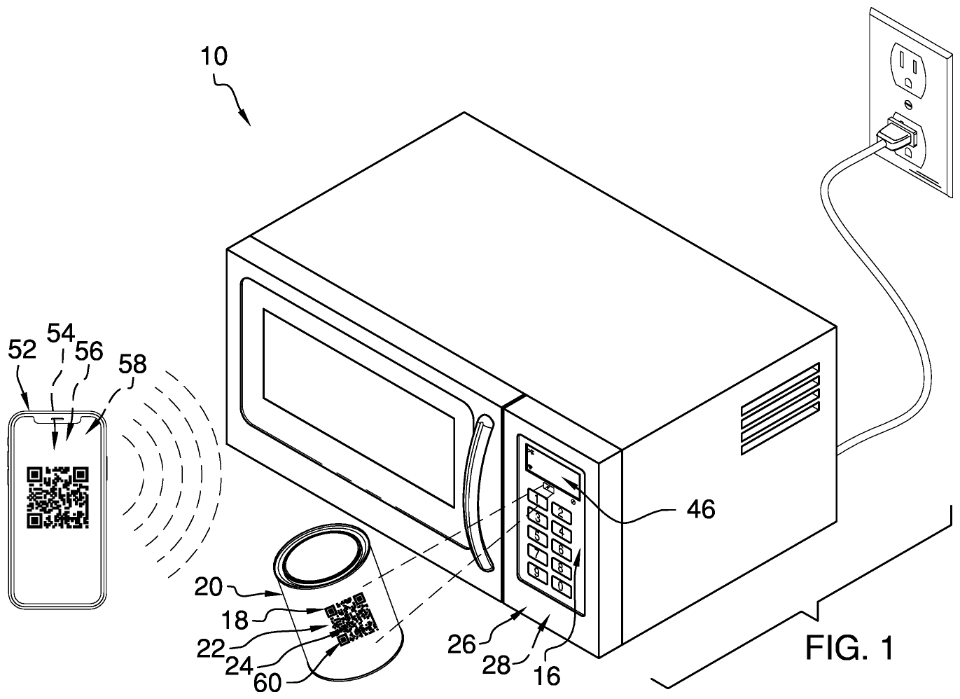

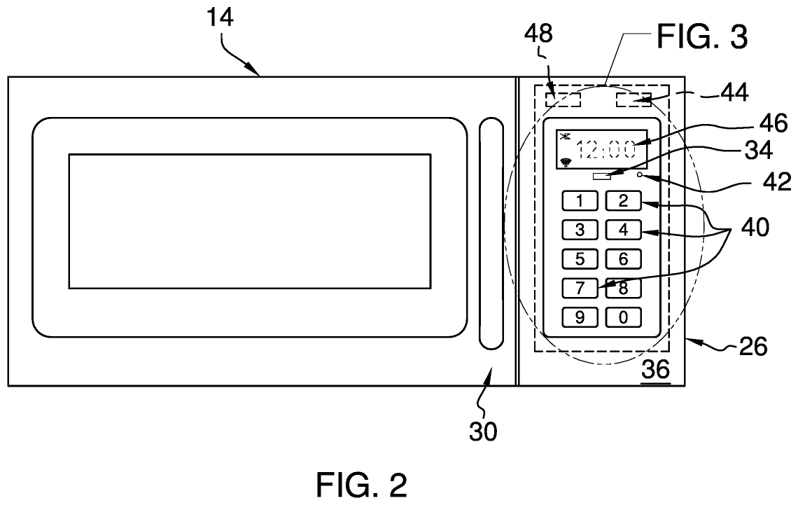

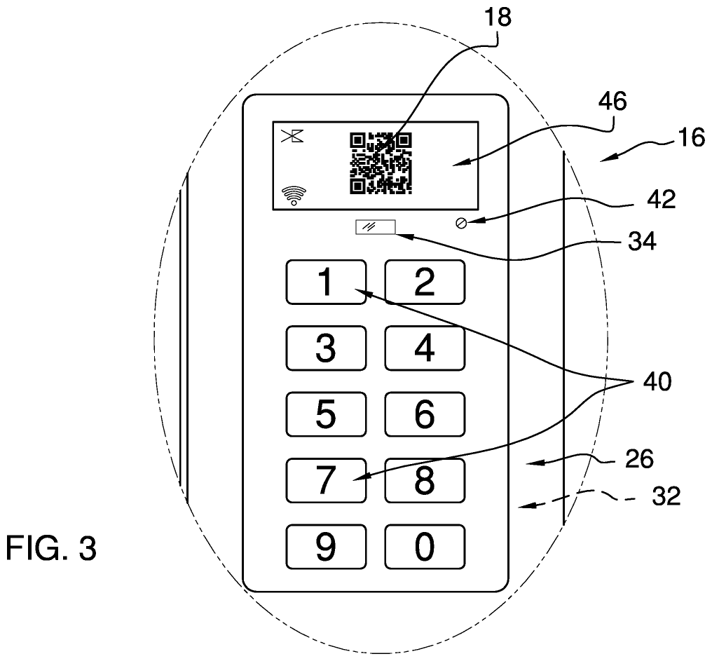

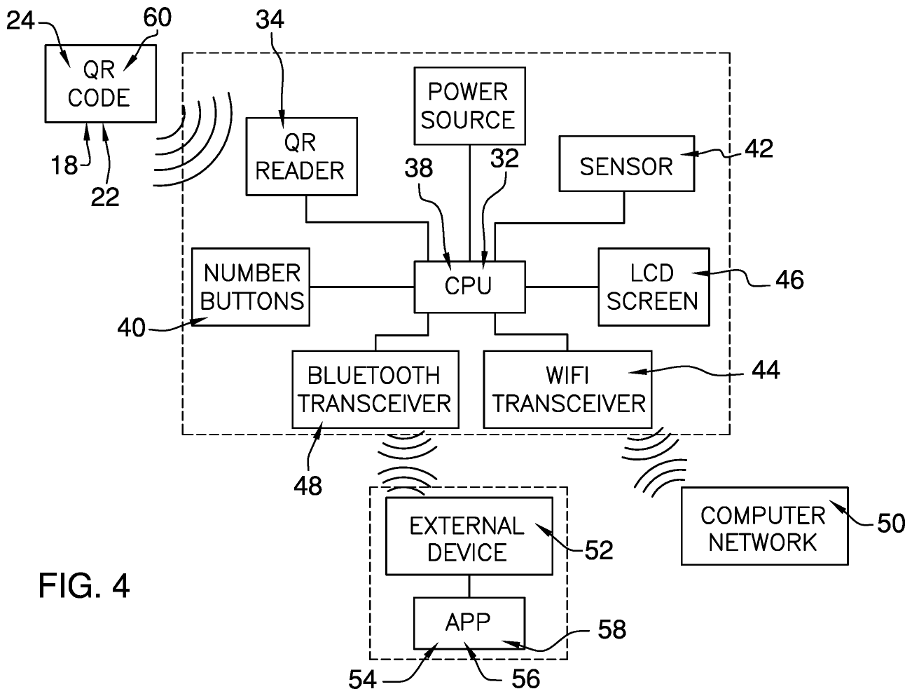

With reference now to the drawings, and in particular to FIGS. 1 through 4 thereof, a new cooking device embodying the principles and concepts of an embodiment of the disclosure and generally designated by the reference numeral 10 will be described.

As best illustrated in FIGS. 1 through 4, the automated cooking device 10 generally comprises an appliance 12 that is configured for at least one of heating and cooking an article positioned therein, such as a foodstuff and a beverage. The appliance 12 may comprise a microwave oven 14, or other heating and cooking means, such as, but not limited to, toaster ovens, fryers, convection ovens, and the like.

A controller 16 is operationally coupled to the appliance 12 and is configured to scan a matrix barcode 18 that is positioned on a package 20 containing the article. The matrix barcode 18 may comprise a quick response code 22, or other code type, such as, but not limited to, Aztec code, Data Matrix, DotCode, Han Zin barcode, and the like. The matrix barcode 18 encodes at least one of a heating instruction and a cooking instruction 24. The controller 16 is configured to actuate the appliance 12 to implement the at least one of the heating instruction and the cooking instruction 24 to selectively heat and cook the article. As the at least one of the heating instruction and the cooking instruction 24 is provided by a manufacture of the article and directly implemented by the controller 16, uncertainty in interpreting written instructions for heating or cooking the article is eliminated.

The controller 16 comprises a housing 26 that defines an interior space 28. The housing 26 is coupled to a front 30 of the appliance 12 so that the controller 16 is accessible to a user. A microprocessor 32 is coupled to the housing 26 and is positioned in the interior space 28. A scanner 34 is coupled to a forward face 36 of the housing 26 and is operationally coupled to the microprocessor 32. The scanner 34 is configured to scan the matrix barcode 18 to obtain the at least one of the heating instruction and the cooking instruction 24. The matrix barcode 18 also may encode a network location path 60 that that leads to a network location storing the at least one of the heating instruction and the cooking instruction 24 for the article.

Actuating programming code 38 is positioned on the microprocessor 32 and enables the microprocessor 32 to selectively actuate the appliance 12 to implement the at least one of the heating instruction and the cooking instruction 24 to selectively heat and cook the article. The actuating programming code 38 may comprise a delay period, such as five seconds, prior to the appliance 12 being actuated.

A plurality of buttons 40 is coupled to the forward face 36 of the housing 26 and is operationally coupled to the microprocessor 32. The buttons 40 are configured to enable manual control of the appliance 12.

A sensor 42 is coupled to the forward face 36 of the housing 26 and is operationally coupled to the microprocessor 32. The sensor 42 is configured for at least one of proximity detection and motion detection. The sensor 42 thus is configured to sense when the package 20 is positioned proximate to the scanner 34 and to signal the microprocessor 32. The microprocessor 32 then is positioned to actuate the scanner 34.

A network transceiver 44 is coupled the housing 26 and is positioned in the interior space 28. The network transceiver 44 is operationally coupled to the microprocessor 32. The microprocessor 32 is positioned to selectively actuate the network transceiver 44 to wirelessly connect to a computer network 50 to access the network location to obtain the at least one of the heating instruction and the cooking instruction 24.

A display 46 is coupled to the forward face 36 of the housing 26 and is operationally coupled to the microprocessor 32. The microprocessor 32 is positioned to actuate the display 46 to present at least one of a description of the article, label information for the article, and the at least one of the heating instruction and the cooking instruction 24.

A local transceiver 48 is operationally coupled to the microprocessor 32 and is positioned in the interior space 28. The microprocessor 32 is positioned to selectively actuate the local transceiver 48 to wirelessly communicate with an electronic device 52 of the user.

Emulation programming code 54 is positioned on the electronic device 52 of the user and enables the electronic device 52 to emulate the display 46. The electronic device 52 thus is positioned to selectively present the at least one of the description of the article, the label information for the article, and the at least one of the heating instruction and the cooking instruction 24 to the user.

Text to audio programming code 56 is positioned on the electronic device 52 of the user and enables the electronic device 52 to broadcast the at least one of the description of the article, the label information for the article, and the at least one of the heating instruction and the cooking instruction 24 to the user.

Notification programming code 58 is positioned on the electronic device 52 of the user and enables the electronic device 52 to notify the user of an event in a heating and cooking procedure of the article, such as completion of heating or cooking, a requirement for rotation of the article, and a requirement for stirring of the article. The notification programming code 58 permits the user to be distal from the appliance 12 during the heating and cooking procedure.

In use, the matrix barcode 18 affixed to the package 20 containing the article is positioned proximate to the scanner 34 for scanning of the at least one of the heating instruction and the cooking instruction 24. The article then is positioned in the appliance 12, either in the package 20 or in a suitable container. The microprocessor 32 then actuates the appliance 12 to implement the at least one of the heating instruction and the cooking instruction 24 to selectively heat and cook the article. When the matrix barcode 18 encodes the network location path 60 of the at least one of the heating instruction and the cooking instruction 24, the network location is accessed via the network transceiver 44 and the computer network 50 to obtain the at least one of the heating instruction and the cooking instruction 24.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the elements is present, unless the context clearly requires that there be only one of the elements.

I claim:

1. An automated cooking device comprising:
an appliance configured for at least one of heating and cooking an article positioned therein; and
a controller operationally coupled to the appliance and being configured for scanning a matrix barcode positioned on a package containing the article, the matrix barcode encoding at least one of a heating instruction and a cooking instruction, the controller being configured for actuating the appliance for implementing the at least one of the heating instruction and the cooking instruction for selectively heating and cooking the article.

2. The automated cooking device of claim 1, wherein the appliance comprises a microwave oven.

3. The automated cooking device of claim 1, wherein the matrix barcode comprises a quick response code.

4. The automated cooking device of claim 1, wherein the controller comprises:
a housing defining an interior space;
a microprocessor coupled to the housing and positioned in the interior space;
a scanner coupled to a forward face of the housing and operationally coupled to the microprocessor, the scanner being configured for scanning the matrix barcode for obtaining the at least one of the heating instruction and the cooking instruction; and
actuating programming code positioned on the microprocessor enabling the microprocessor for selectively actuating the appliance for implementing the at least one of the heating instruction and the cooking instruction for selectively heating and cooking the article.

5. The automated cooking device of claim 4, wherein the housing is coupled to a front of the appliance such that the controller is accessible to a user.

6. The automated cooking device of claim 4, further including a plurality of buttons coupled to the forward face of the housing and operationally coupled to the microprocessor wherein the buttons are configured for enabling manual control of the appliance.

7. The automated cooking device of claim 4, further including a sensor coupled to the forward face of the housing and operationally coupled to the microprocessor, the sensor being configured for at least one of proximity detection and motion detection, wherein the sensor is configured for sensing the package being positioned proximate to the scanner and for signaling the microprocessor, such that the microprocessor is positioned for actuating the scanner.

8. The automated cooking device of claim 4, further including:
the matrix barcode encoding a network location path to a network location storing the at least one of the heating instruction and the cooking instruction for the article; and
a network transceiver coupled the housing and positioned in the interior space, the network transceiver being operationally coupled to the microprocessor such that the microprocessor is positioned for selectively actuating the network transceiver for wirelessly connecting to a computer network for accessing the network location for obtaining the at least one of the heating instruction and the cooking instruction.

9. The automated cooking device of claim 8, wherein the matrix barcode comprises a quick response code.

10. The automated cooking device of claim 4, further including a display coupled to the forward face of the housing and operationally coupled to the microprocessor such that the microprocessor is positioned for actuating the display for presenting at least one of a description of the article, label information for the article, and the at least one of the heating instruction and the cooking instruction.

11. The automated cooking device of claim 10, further including:
a local transceiver operationally coupled to the microprocessor and positioned in the interior space such that the microprocessor is positioned for selectively actuating the local transceiver for wireless communication with an electronic device of the user; and
emulation programming code positioned on the electronic device of the user enabling the electronic device for emulating the display, such that the at least one of the description of the article, the label information for the article, and the at least one of the heating instruction and the cooking instruction is presented to the user via the electronic device.

12. The automated cooking device of claim 11, further including text to audio programming code positioned on the electronic device of the user enabling the electronic device for broadcasting the at least one of the description of the article, the label information for the article, and the at least one of the heating instruction and the cooking instruction to the user.

13. The automated cooking device of claim 11, further including notification programming code positioned on the electronic device of the user enabling the electronic device for notifying the user of an event in a heating and cooking procedure of the article.

14. An automated cooking device and matrix barcode combination comprising:
a matrix barcode coupled to a package containing an article, the matrix barcode encoding at least one of a heating instruction and a cooking instruction;
an appliance configured for at least one of heating and cooking the article when the article is positioned therein; and
a controller operationally coupled to the appliance and being configured for scanning the matrix barcode, the controller being configured for actuating the appliance for implementing the at least one of the heating instruction and the cooking instruction for selectively heating and cooking the article.

15. The automated cooking device and matrix barcode combination of claim 14, wherein the controller comprises:
a housing defining an interior space;
a microprocessor coupled to the housing and positioned in the interior space;
a scanner coupled to a forward face of the housing and operationally coupled to the microprocessor, the scanner being configured for scanning the matrix barcode for obtaining the at least one of the heating instruction and the cooking instruction; and
actuating programming code positioned on the microprocessor enabling the microprocessor for selectively actuating the appliance for implementing the at least one of the heating instruction and the cooking instruction for selectively heating and cooking the article.

16. The automated cooking device and matrix barcode combination of claim 15, further including:
a display coupled to the forward face of the housing and operationally coupled to the microprocessor such that the microprocessor is positioned for actuating the display for presenting at least one of a description of the article, label information for the article, and the at least one of the heating instruction and the cooking instruction;
the matrix barcode encoding a network location path to a network location storing the at least one of the heating instruction and the cooking instruction for the article;
a network transceiver coupled the housing and positioned in the interior space, the network transceiver being operationally coupled to the microprocessor such that the microprocessor is positioned for selectively actuating the network transceiver for wirelessly connecting to a computer network for accessing the network location for obtaining the at least one of the heating instruction and the cooking instruction;
a local transceiver operationally coupled to the microprocessor and positioned in the interior space such that the microprocessor is positioned for selectively actuating the local transceiver for wireless communication with an electronic device of the user; and
emulation programming code positioned on the electronic device of the user enabling the electronic device for emulating the display, such that the at least one of the description of the article, the label information for the article, and the at least one of the heating instruction and the cooking instruction is presented to the user via the electronic device.

17. The automated cooking device and matrix barcode combination of claim 16, further including text to audio programming code positioned on the electronic device of the user enabling the electronic device for broadcasting the at least one of the description of the article, the label information for the article, and the at least one of the heating instruction and the cooking instruction to the user.

18. The automated cooking device and matrix barcode combination of claim 16, further including notification programming code positioned on the electronic device of the user enabling the electronic device for notifying the user of an event in a heating and cooking procedure of the article.

19. The automated cooking device and matrix barcode combination of claim 14, wherein the appliance comprises a microwave oven.

20. An automated cooking device comprising:
an appliance configured for at least one of heating and cooking an article positioned therein, the appliance comprising a microwave oven;
a controller operationally coupled to the appliance and being configured for scanning a matrix barcode positioned on a package containing the article, the matrix barcode encoding at least one of a heating instruction and a cooking instruction, the controller being configured for actuating the appliance for implementing the at least one of the heating instruction and the cooking instruction for selectively heating and cooking the article, the matrix barcode comprising a quick response code, the controller comprising:
a housing defining an interior space, the housing being coupled to a front of the appliance such that the controller is accessible to a user,
a microprocessor coupled to the housing and positioned in the interior space,
a scanner coupled to a forward face of the housing and operationally coupled to the microprocessor, the scanner being configured for scanning the matrix barcode for obtaining the at least one of the heating instruction and the cooking instruction, the matrix barcode encoding a network location path to a network location storing the at least one of the heating instruction and the cooking instruction for the article,
actuating programming code positioned on the microprocessor enabling the microprocessor for selectively actuating the appliance for implementing the at least one of the heating instruction and the cooking instruction for selectively heating and cooking the article,
a plurality of buttons coupled to the forward face of the housing and operationally coupled to the microprocessor wherein the buttons are configured for enabling manual control of the appliance,
a sensor coupled to the forward face of the housing and operationally coupled to the microprocessor, the sensor being configured for at least one of proximity detection and motion detection, wherein the sensor is configured for sensing the package being positioned proximate to the scanner and for signaling the microprocessor, such that the microprocessor is positioned for actuating the scanner,
a network transceiver coupled the housing and positioned in the interior space, the network transceiver being operationally coupled to the microprocessor such that the microprocessor is positioned for selectively actuating the network transceiver for wirelessly connecting to a computer network for accessing the network location for obtaining the at least one of the heating instruction and the cooking instruction,
a display coupled to the forward face of the housing and operationally coupled to the microprocessor such that the microprocessor is positioned for actuating the display for presenting at least one of a description of the article, label information for the article, and the at least one of the heating instruction and the cooking instruction, and
a local transceiver operationally coupled to the microprocessor and positioned in the interior space such that the microprocessor is positioned for selectively actuating the local transceiver for wireless communication with an electronic device of the user;
emulation programming code positioned on the electronic device of the user enabling the electronic device for emulating the display, such that the at least one of the description of the article, the label information for the article, and the at least one of the heating instruction and the cooking instruction is presented to the user via the electronic device;
text to audio programming code positioned on the electronic device of the user enabling the electronic device for broadcasting the at least one of the description of the article, the label information for the article, and the at least one of the heating instruction and the cooking instruction to the user; and
notification programming code positioned on the electronic device of the user enabling the electronic device for notifying the user of an event in a heating and cooking procedure of the article.
